(19) United States
(12) Patent Application Publication
(10) Pub. No.: US 2005/0247228 A1
(43) Pub. Date: Nov. 10, 2005

(54) Apparatus with slide-in unit and coating device attached thereto

(75) Inventors: Franz Troxler, Zofingen (CH); Roland Kollmer, Steinen (DE)

Correspondence Address: VENABLE LLP, P.O. BOX 34385, WASHINGTON, DC, 20045-9998, US

(73) Assignee: MULLER MARTINI HOLDING AG, Hergiswil (CH)

(21) Appl. No.: 11/121,112

(22) Filed: May 4, 2005

(30) Foreign Application Priority Data
May 4, 2004 (EP) 04405277.7-1251

(51) Int. Cl. B41F 23/08

(52) U.S. Cl. 101/480; 101/416.1

(57) ABSTRACT

An apparatus is provided comprising a slide-in unit including at least one plate cylinder, one image-carrying cylinder and one counter-pressure cylinder operatively arranged relative to one another. A coating device, comprising a doctor blade inking device and an application roller, are operatively arranged relative to the slide-in unit to apply a coating to an endless substrate passing through the slide-in unit. The image-carrying cylinder is adjustably arranged in a direction parallel to the rotational axis of the image-carrying cylinder to adjust at least a lateral registration of the image-carrying cylinder with respect to the endless substrate.

### CROSS-REFERENCE TO RELATED APPLICATION

This application claims the priority of European Patent Application No. 04405277.7-1251, filed on May 4, 2004, the subject matter of which is incorporated herein by reference. The disclosure of all U.S. and foreign patents and patent applications mentioned below are also incorporated herein by reference.

### BACKGROUND OF THE INVENTION

1. Field of the Invention

The invention relates to an apparatus provided with a slide-in unit, as well as a coating device attached to the slide-in unit. The slide-in unit comprises at least one plate cylinder, one image-carrying cylinder, and one counter-pressure cylinder. The attached coating device is provided with a doctor blade inking device and an application roller.

2. Related Art

European Patent Document EP 1 389 523 A discloses a sheet-fed rotary press which comprises several offset printing units for the multicolored printing. This machine furthermore comprises a coating device in the form of a varnishing module which is provided with a metering system having an application roller and a doctor blade inking device. The varnishing module can be used to finish printed sheets, for example, by applying a coat of varnish. The application roller for the varnish module is a raster roller which removes the liquid medium applied by the doctor blade inking device.

For a sheet-fed press, it is furthermore known to attach such a coating device to a slide-in unit for a rubber-blanket cylinder, thus making it possible to coat and/or imprint registration non-critical applications with a coat of varnish. The coating device is inserted and removed so as to alternate with a rubber-blanket washing device.

### SUMMARY OF THE INVENTION

According to an exemplary embodiment of the invention, there is provided an apparatus comprising: a slide-in unit including at least one plate cylinder, one image-carrying cylinder and one counter-pressure cylinder operatively arranged relative to one another; and a coating device, comprising a doctor blade inking device and an application roller, operatively arranged relative to the slide-in unit to apply a coating to an endless substrate passing through the slide-in unit; wherein the image-carrying cylinder is adjustably arranged in a direction parallel to the rotational axis of the image-carrying cylinder to adjust at least a lateral registration of the image-carrying cylinder with respect to the endless substrate.

Thus, an apparatus according to the invention makes it possible to adjust the image-carrying cylinder in a direction parallel to the rotational axis, at least to adjust a lateral registration, wherein the slide-in unit is intended for coating an endless substrate. With the apparatus according to the invention it is possible to coat even registration-critical applications, for example, a title or individual text passages on an endless substrate and in particular on an endless paper web. The apparatus according to the invention can thus be used not only for full-surface coating with a varnish, but also for partial coating, also called spot coating, and in particular for applying a coat of varnish that must be positioned precisely. With an apparatus of this type, only the image-carrying cylinder, the counter-pressure cylinder, and the coating device are required. The normally-used plate cylinder is not used in this case. It is not necessary for the counter-pressure cylinder to be displaceable to the side since it does not influence the lateral registration.

According to a further exemplary embodiment, the slide-in unit is an offset slide-in unit for a printing press, used to imprint an endless substrate and especially an endless paper web. Furthermore, according to another embodiment, the slide-in unit may be a wet offset slide-in unit.

According to yet another embodiment of the invention, a particularly precise application and/or coating with varnish is ensured if the image-carrying cylinder can be adjusted for setting the longitudinal registrations relative to the direction of movement of the endless substrate. As a result, an endless substrate can be provided with varnish at a precise, predetermined location. In that case, the image-carrying cylinder can be adjusted for the lateral registration as well as the longitudinal registration.

The slide-in unit can be used in the standard way following the removal of the coating device, wherein the plate cylinder is then coated as usual with ink from an inking unit.

Additional and advantageous features will become apparent from a consideration of the following description, as well as the drawings and examples.

### BRIEF DESCRIPTION OF THE DRAWINGS

An exemplary embodiment of the invention is explained in further detail with the aid of the accompanying drawings.

FIG. 1 depicts a cross-sectional view of an exemplary embodiment of the apparatus according to the invention.

FIG. 2 depicts a three-dimensional schematic view of a printed sheet produced with the apparatus according to the invention.

FIG. 3 depicts a three-dimensional schematic view of the apparatus according to the invention as shown in FIG. 1.

FIG. 4 schematically depicts an apparatus according to FIG. 3, wherein cylinders for a larger format have been installed in this case.

### DETAILED DESCRIPTION OF THE INVENTION

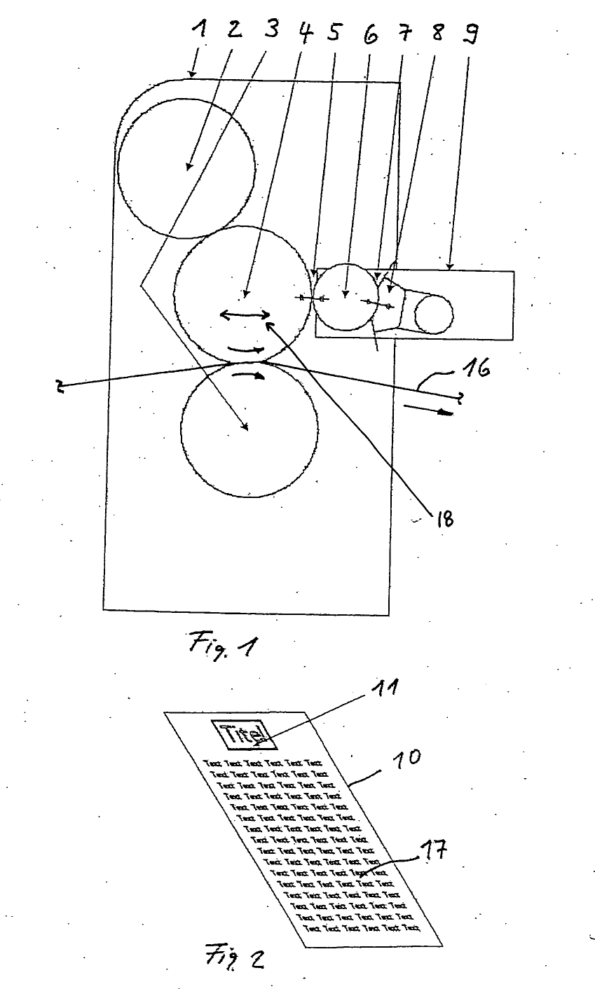

Referring to FIGS. 1 and 3, there is shown an apparatus according to an exemplary embodiment of the invention which comprises a slide-in unit 1 for an offset printing press, in particular a wet offset printing press. The slide-in unit 1 according to FIG. 3 comprises two spaced-apart bearing plates 14 and 15 with a plate cylinder 2, an image-carrying cylinder 4, in particular a rubber-blanket cylinder, as well as a counter-pressure cylinder 3 positioned thereon. The slide-in unit 1 is positioned in a printing unit 13, which is only partially indicated herein, and comprises suitable drive means for the aforementioned cylinders 2, 4 and 3.

According to FIG. 1, an endless substrate 16 and in particular an endless web of paper moves between the cylinders 4 and 3. The cylinders 2, 4 and 3 are adapted to the format to be printed. In the embodiment according to FIG. 4, the cylinders 2, 4 and 3 are replaced by the cylinders 2′, 4′ and 3′. These cylinders 21, 4′, and 3′ have a larger diameter and/or circumference and are correspondingly designed for a larger format. The format dependence is due to the imprinting of an endless substrate and does not exist for sheet printing.

A coating device 9 is attached to the image-carrying cylinder 4 and/or 4′. This coating device 9 is attached to the slide-in unit 1 with means that are not shown herein, such that it is relatively easy to install and remove. The slide-in unit 1 can thus be used in the standard way for printing, either with the coating device 9 or without it, wherein an inking unit and the plate cylinder 2 are needed in the latter case.

The coating device 9 is known per se and comprises an application roller 6, a doctor blade inking device 8 which contains a liquid medium, in particular a so-called flexo color or flexo varnish. The liquid medium is applied in the known manner to the rotating application roller 6. The application roller 6 in particular is a so-called raster roller in this case. A contact gap 7 exists between the application roller 6 and the doctor blade inking device 8. An additional gap is found between the image-carrying cylinder 4 and the application roller 6. The doctor blade inking device 8 pushes against the outside surface of the application roller 6, wherein the contact gap 7 can be adjusted. If the image-carrying cylinder 4 is added, the application roller 6 with the doctor blade inking device 8 makes contact with the image-carrying cylinder 4 via the gap 5. The medium in the doctor blade inking device 8 is transferred in the process to the image-carrying cylinder 4 and finally to the substrate 16.

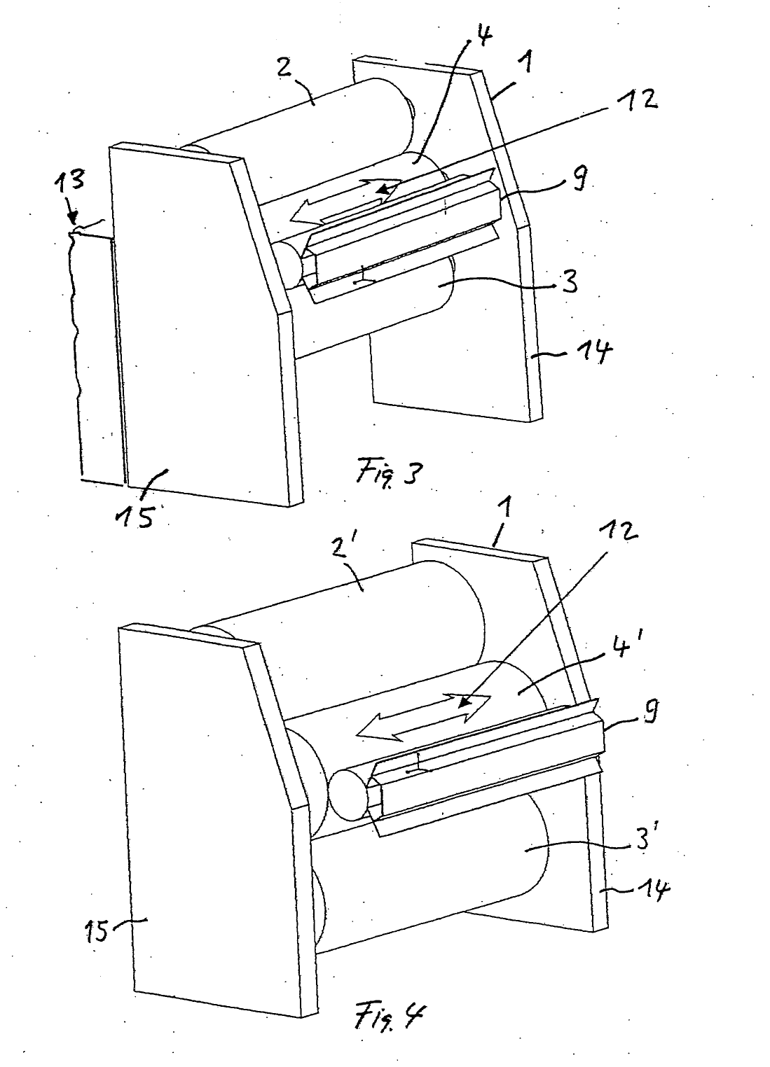

In FIG. 1, the two cylinders 4 and 3 are driven such that the endless substrate 16 flows from the left to the right between these two rollers. Before the endless substrate 16 reaches the two cylinders 3 and 4, it is first imprinted by means of upstream installed printing units 13, which are not shown in further detail herein, e.g. with the text 17 shown in FIG. 2. The title of text 17 can be text or a picture. Similarly, text 17 can contain pictures and the like. In each case, the slide-in unit 1 imprints and/or coats the title and/or text 17 with a coat of varnish 11, as shown in FIG. 2. The varnish can be a transparent varnish or a colored varnish, such that the title and/or text can be emphasized visually or optically.

According to FIGS. 3 and 4, the image-carrying cylinder 4 can be adjusted laterally in the directions of double arrow 12 and thus parallel to its rotational axis, wherein this adjustment accomplishes registration transverse to the flow of the endless substrate 16. In another preferred embodiment, as shown in FIG. 1, the image-carrying cylinder 4 can also be adjusted longitudinally in the direction of double arrow 18 and thus transverse to its rotational axis, wherein this adjustment accomplishes registration parallel to the flow of the endless substrate 16. As a result, the lateral registration and the longitudinal registration, respectively, can be adjusted. The coat of varnish to be applied can thus be adjusted by correspondingly positioning the image-carrying cylinder 4 in such a way that the varnish coat 11 is positioned precisely, relative to the upstream imprint. The imprint and the varnish coat 11 are thus aligned in registration.

As previously mentioned, the cylinders 2, 4 and 3 can be replaced to effect a format change. For example, the cylinders 2, 4 and 3 can be replaced with the cylinders 2′, 4′ and 3′ for a larger format while the same coating device 9 is used. Once the printing operation is turned off, the coating device 9 opens up the gap 5, thereby preventing any further application by the coating device 9. The printed-on substrate 17 and/or the endless paper web is cut in a cutting device that is not shown herein, thus generating the corresponding printed sheets 10.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. An apparatus comprising:
a slide-in unit including at least one plate cylinder, one image-carrying cylinder and one counter-pressure cylinder operatively arranged relative to one another; and
a coating device, comprising a doctor blade inking device and an application roller, operatively arranged relative to the slide-in unit to apply a coating to an endless substrate passing through the slide-in unit;
wherein said image-carrying cylinder is adjustably arranged in a direction parallel to the rotational axis of the image-carrying cylinder to adjust at least a lateral registration of the image-carrying cylinder with respect to the endless substrate.

2. The apparatus according to claim 1, wherein the slide-in unit is an offset slide-in unit.

3. The apparatus according to claim 1, wherein the image carrying cylinder is further adjustably arranged in a direction perpendicular to the rotational axis of the image-carrying cylinder to adjust a longitudinal registration.

4. The apparatus according to claim 1, wherein the coating device is arranged to partially coat the endless substrate.

5. The apparatus according to claim 4, wherein the at least one plate cylinder, the counter-pressure cylinder and the image-carrying cylinder are replaceable for a format change.

6. A method of operating a wet offset printing device comprising: utilizing the apparatus of claim 1 in the offset printing device.
